(19) United States
(12) Patent Application Publication
(10) Pub. No.: US 2005/0210733 A1
(43) Pub. Date: Sep. 29, 2005

(54) Deluxe hang around bait holder

(76) Inventors: Joseph F. Wozniak, Brick, NJ (US); Ronald A. Neville, Brick, NJ (US)

Correspondence Address: JOSEPH F. WOZNIAK, 954 QUINCY DRIVE, BRICK, NJ, 08724, US

(21) Appl. No.: 10/807,481

(22) Filed: Mar. 23, 2004

(51) Int. Cl. A01K 97/04; A01K 97/06

(52) U.S. Cl. 43/55; 43/54.1

(57) ABSTRACT

This apparatus is a box for cut and /or live fishing bait having a main body portion including a bottom wall, front, back and first and second side walls, defining a principle interior chamber with an open top. Two “J” shaped brackets/handles extend upward from the main body of the device, facing in opposite directions, enabling the apparatus to hang from the railing of a boat, pier, dock or fishing area and maintaining stability against turbulent water/windy conditions. The device can also be placed on a flat surface when fishing from the shoreline or any area that does not have a railing readily available. Attached to the outside of one side of the bait box main body is a hollow, circular shaped cup holder and on the outside of the opposite side of the bait box main body is a cylindrical, tubular tool holder. The device attaches to the railing of a boat, pier, dock or fishing area and satisfies the needs of fishermen as a personal, convenient, stable and safe way to transport and have cut and/or live fishing bait readily available, while incorporating a tool holder for assisting in retrieving hooks from fish, and a cup holder for the desired beverage of the fishermen.

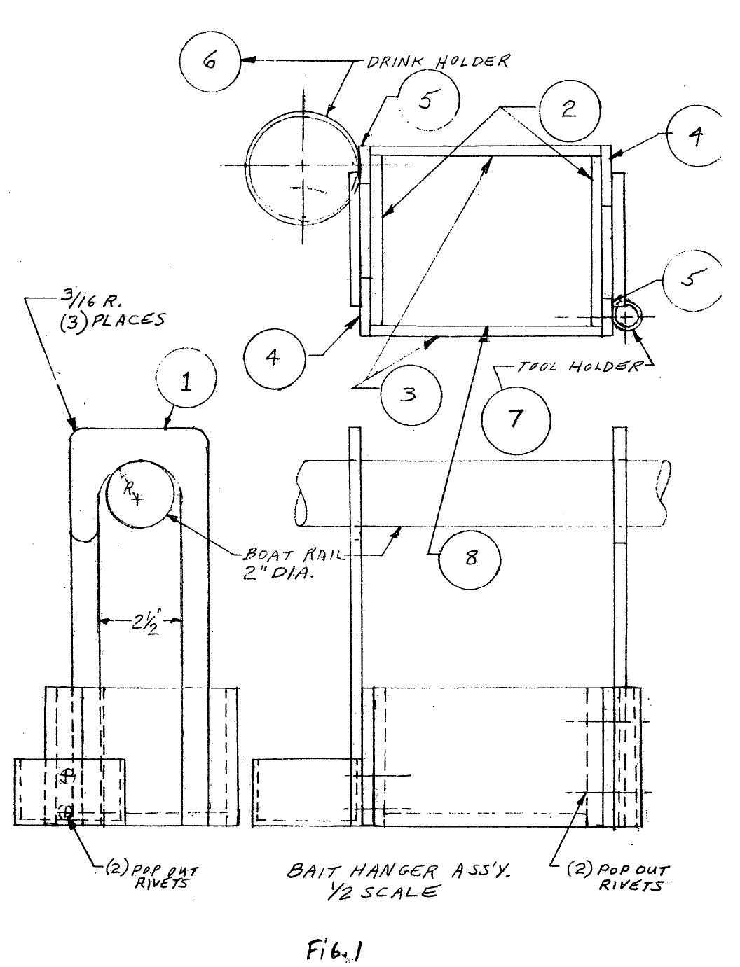

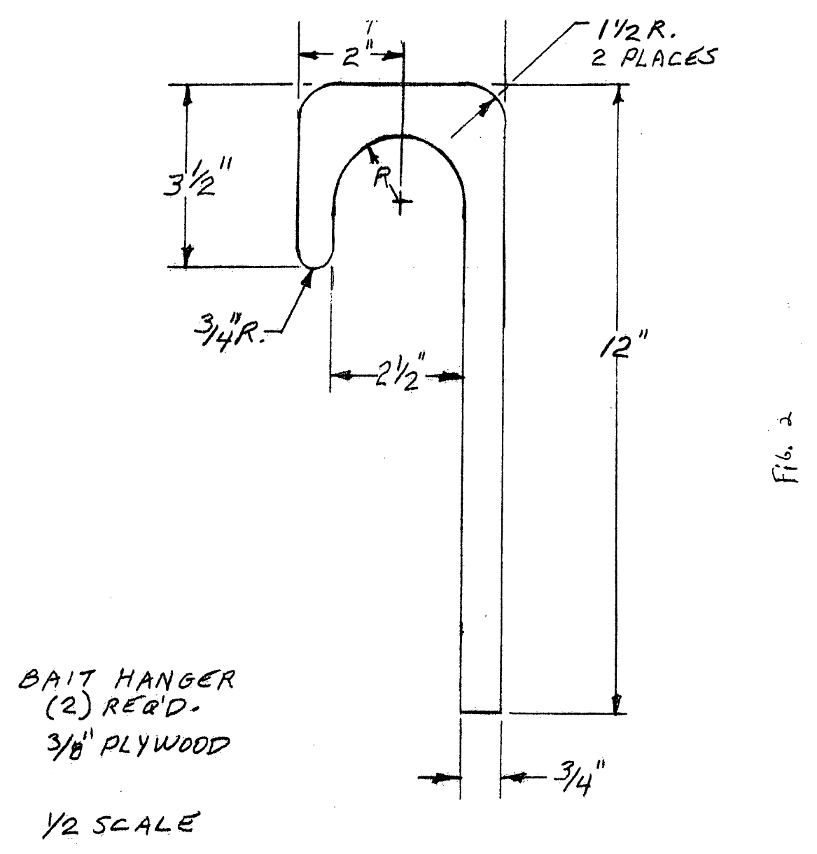

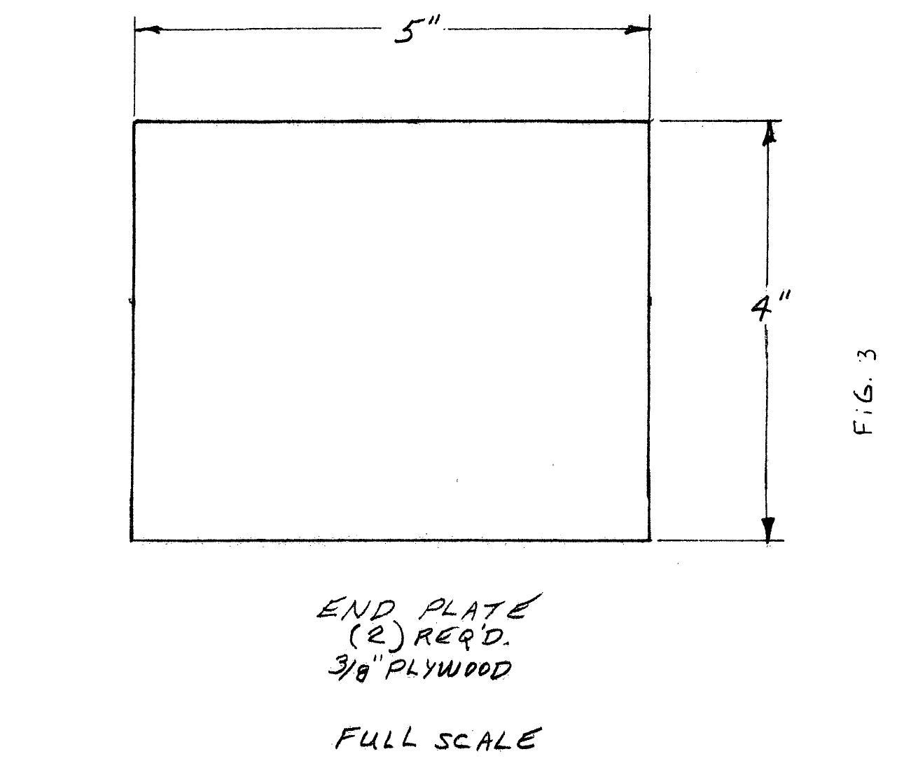

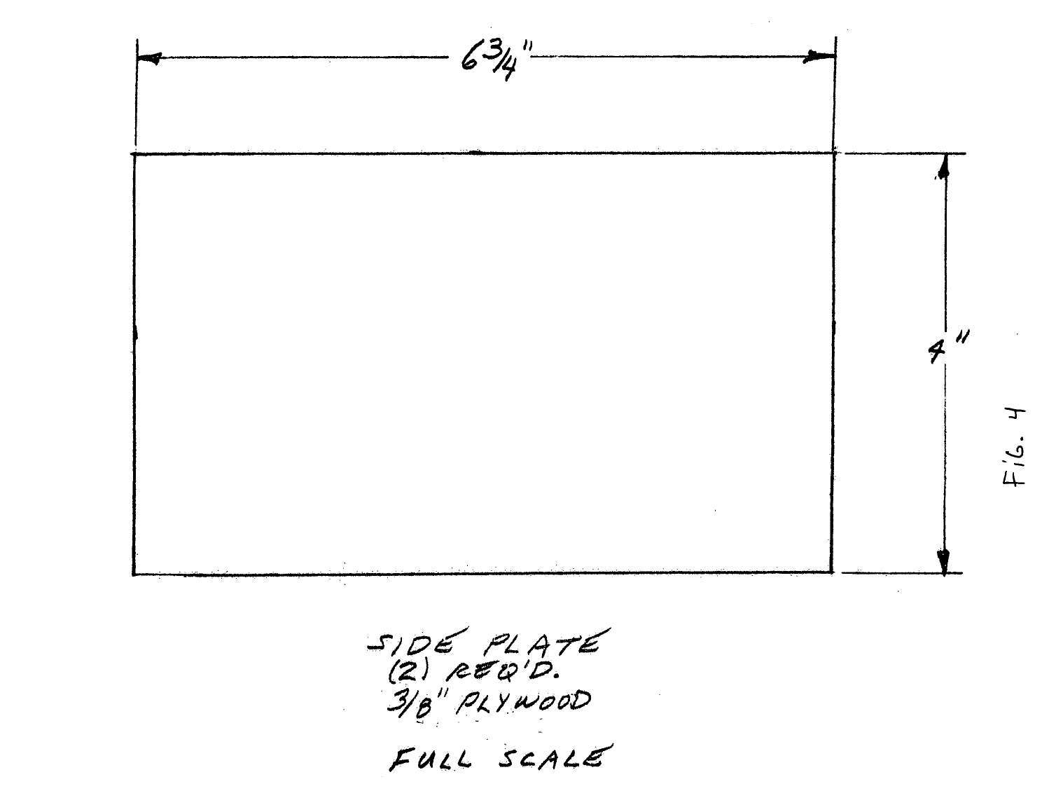

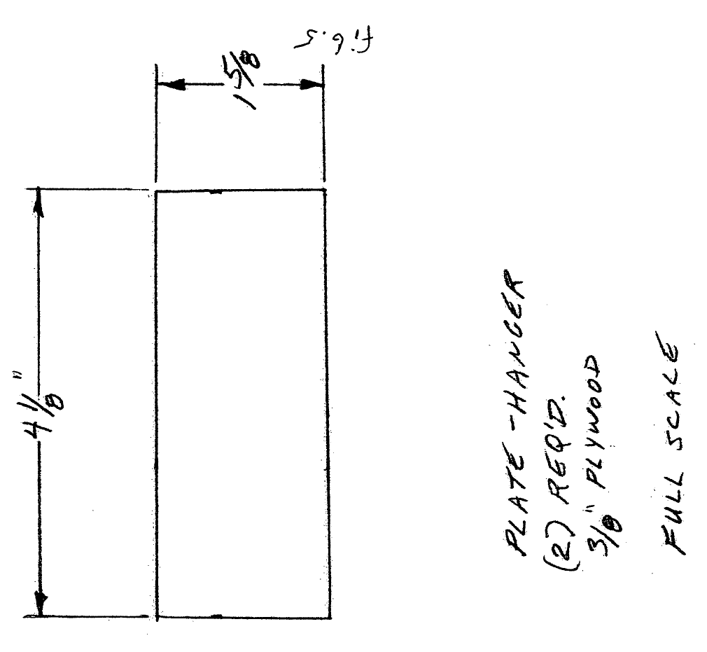

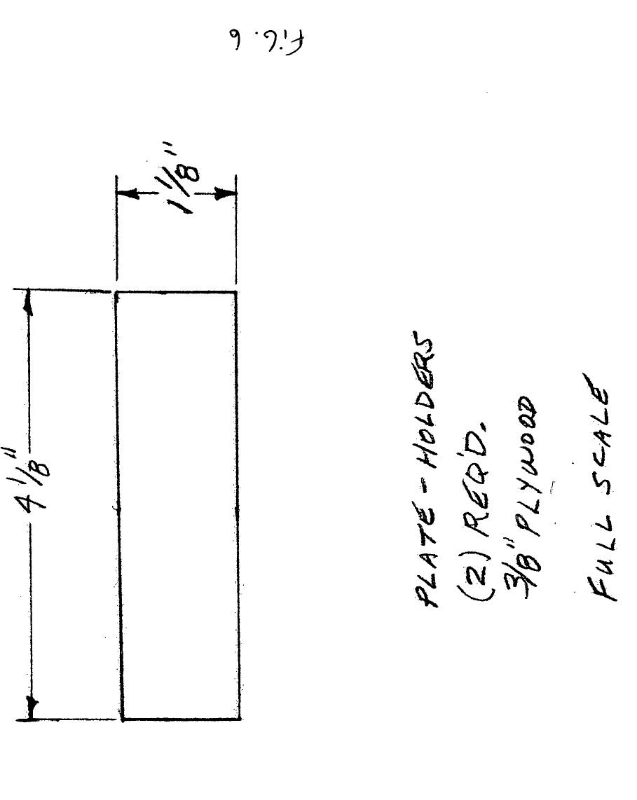

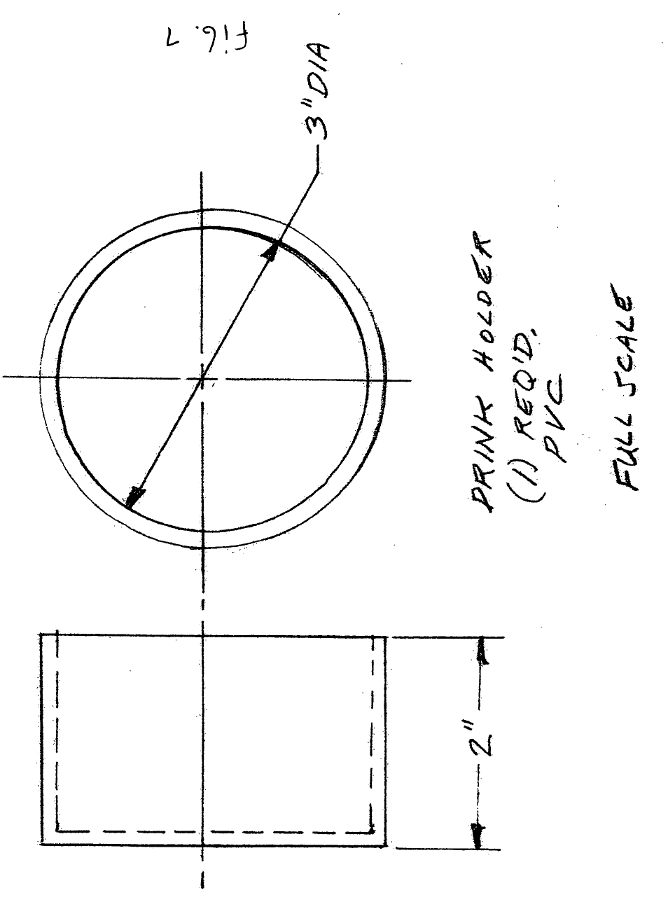

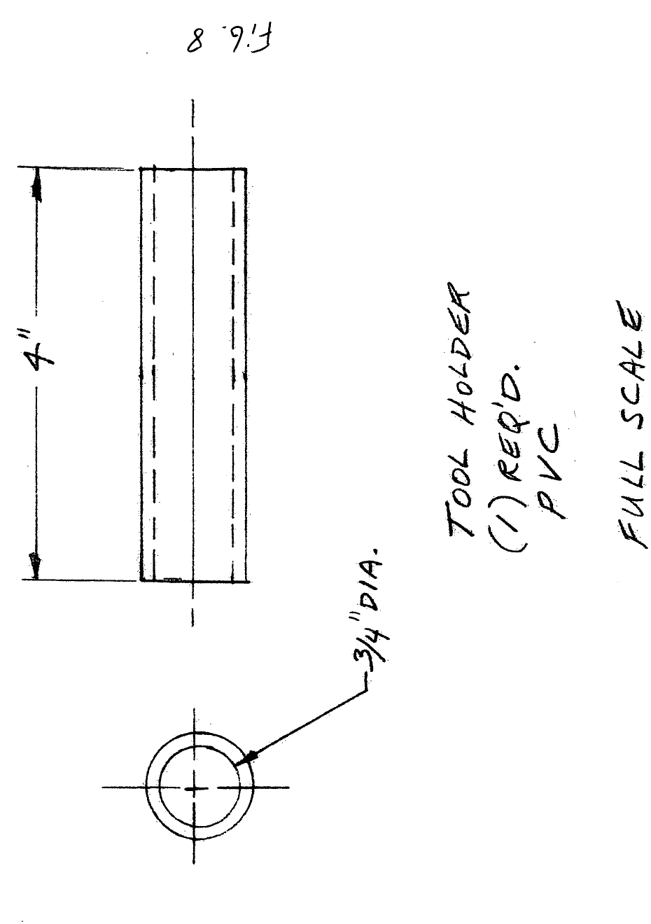

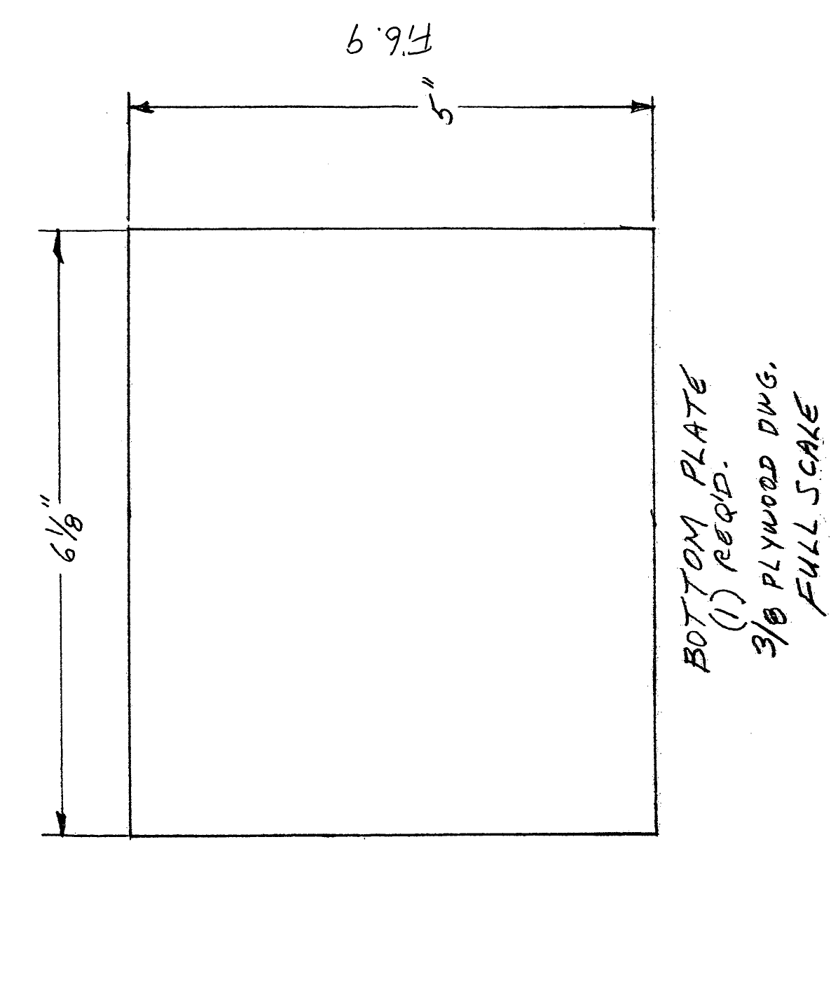

### FIELD OF THE INVENTION

This invention relates to a device for containing bait for fishing. More specifically, the invention relates to a device for holding cut or live bait that hangs from two handles from the rail of a boat, that is readily accessible and has an extension one side to hold tools and the other side to hold a cup, can or bottled beverage.

### BACKGROUND OF THE INVENTION

Many devices have been provided for convenient carrying of baits and tackle for fishing. Such devices have included conventional tackle boxes, compartmentalized plastic containers, minnow pails and buckets and the like.

Various baits such as clams, bunker, squid, worms fish eggs and killies are utilized for fishing. Many of such types of baits are stored in a central area away from the fishermen. A need existed for a convenient and portable way for fishermen to access their bait. Numerous types of fishing equipment has been provided in prior art that are adapted to retain tackle, bait and the like. For example, U.S. Pat. Nos. 3,113,818; 3,859,747; 4,744,614 and 4,890,414 are illustrative of such prior art. While these units may be suitable for the particular purpose to which they address, they would not be as suitable for the purposes of the present invention as heretofore described.

### SUMMARY OF INVENTION

It is a principal object of the present invention to provide a convenient, portable and easily accessible way to retain and transport one or more cut and or live types of bait. In accordance with an important aspect of the invention, two handles are provided with opposite closure angles to hang from a boat rail to ensure stability while hanging from a boat rail.

A further object is to provide a cut and or live bait holder that is simple and easy to use.

A still further object is to provide a cut and or live bait holder that is economical in cost to manufacture.

Briefly, the invention provides a device that retains, is easily accessible and transports cut and or live bait that hangs by two “J” shaped brackets/handles and extends upward from the main body of the device, facing in opposite directions, enabling the apparatus to hang from the railing of a boat, pier, dock or fishing area and maintains stability against turbulent water/windy conditions. The device includes an extension on its side for holding tools such as pliers, knives or clippers. The opposite side of the device contains holder for a cup, can or bottled beverage.

Further aspects and advantages of the invention will become apparent from the following detailed description, claims and accompanying drawings. However, the drawings are illustrative only, and changes may be made in specific construction illustrated and described within the scope of amended claims.

1. A personal, convenient, stable and safe device for holding, transporting and having readily available cut and live fishing bait including two appendages, one, to hold tools to assist the fisherman and, two, a beverage holder that attaches by hanging from the railing of a boat, pier, dock or stands alone on a flat surface of any fishing area which comprises:
(a) A container being box-shaped with including a bottom wall, front, back and first and second side walls, defining a principle chamber with an open top;
(b) Two “J” shaped brackets/handles/arms extending upward from the main body of the device, facing in opposite directions enabling the device to attach and hang to the railing of a boat, pier railing, dock railing or any other fishing area with any railing type of structures present. The “J” shaped brackets/handles/arms provide stability in turbulent sea/wind conditions. The device may also be placed on a flat surface when/where no railings are readily available;
(c) Two appendages, one on either side of the box-shaped container incorporating a tool holder for pliers/knives etc., and a beverage holder sized to accommodate a variety of sizes of beverage including cans, cups and bottles;
(d) Interchangeability by allowing the device to hang from railings with either of the two appendages on the side of preference (left handed/right handed) of the fisherman.
